(19) United States
(12) Patent Application Publication
(10) Pub. No.: US 2017/0226650 A1
(43) Pub. Date: Aug. 10, 2017

(54) METALLIC PICTURE PRINT WITH THE USE OF DIFFERENTIALLY OXIDIZED AND/OR NITRIDIZED LAYERS, AND METHOD FOR MAKING THE SAME

(71) Applicant: Xiaojiang Zhang, Edmonton (CA)

(72) Inventor: Xiaojiang Zhang, Edmonton (CA)

(21) Appl. No.: 15/015,125

(22) Filed: Feb. 4, 2016

(51) Int. Cl. C25D 11/02; B41M 5/50; B41M 3/06; C25D 11/26; B44F 11/02

(52) U.S. Cl. CPC C25D 11/022; C25D 11/26; B44F 11/02; B41M 3/06; B41M 5/50

(57) ABSTRACT

The present invention relates to a metal such as titanium and niobium with differentially oxidized and/or nitridized layers for a metallic picture print, and method for producing the same. More specifically, this invention relates to a metal surface modified by differential oxidation and/or nitridation for making durable metallic picture prints to limit degradation to a picture print caused by UV radiation and chemical reactions.

### BACKGROUND

For many years paper-based media has been widely used for making conventional picture prints such as photographic prints. One of the most significant advantages of the paper-based prints is the high image resolution. For example, some modern photo printing method can achieve a resolution of 2880 dots per inch (dpi) on photo papers. However, picture prints produced on paper have several long-existing disadvantages including (i) aging problem, (ii) being UV-sensitive, and (iii) being water/humidity sensitive.

It is therefore an object of the present invention to provide a method for producing ultra-long life time, UV-proof and water-proof picture prints using metals with differentially oxidized and/or nitridized surface.

Some metals such as titanium and niobium are potential candidates for making durable metallic picture prints having ultra-long life time. For instance, titanium is a highly corrosion resistant and human body compatible metal which has been widely used for various ranges of applications such as in medical and jewelry industries. The coloration of titanium and niobium is usually achieved by a simple electrochemical oxidation process called anodization in which the surface of the metal is chemically oxidized. Such a coloration is due to thin film interference of light. This simple and cost-effective coloring process for titanium and niobium is very popular in the jewelry industry. Another method that is widely used for coloring titanium and niobium is thermal-induced oxidation. For titanium and niobium, the chemical or thermal oxidation process will further protect the metal by increasing the surface hardness and providing an inert surface oxide/nitride layer. Generally speaking, the colors created by oxidation and/or nitridation is very durable because of the chemical bonding between the metal matrix and the oxide and/or nitride layer.

A method of printing inks on metal to make colored metal films has been discussed in U.S. Pat. App. 20150251472. U.S. Pat. No. 5,160,599 by Kobayashi, et al., discloses a method for forming colors on titanium. In the electrochemical anodization process, the color of titanium can be controlled by adjusting the current or the voltage. U.S. Pat. No. 7,803,462 by Takahashi, et al., discloses a method for protecting and preserving colored titanium. The colored titanium surface was protected by a polymer coating. More recently, it has been suggested in U.S. Pat. No. 6,710,287 B2 that laser beam can be used to oxidize and color the titanium surface in a high speed.

### DESCRIPTION OF THE DRAWINGS

A preferred embodiment of the present invention is described below with reference to the accompanying drawings, in which:

FIG. 1 is a cross-sectional illustration of a metal-based graphic print.

FIG. 2 shows a photograph of a titanium metal and a titanium-based graphic print with a high resolution image shown on the print surface.

FIG. 3 is a cross-sectional illustration of a metal-based graphic print in which the metal is deposited on a substrate.

### SUMMARY OF THE INVENTION

It is known that the coloration of some transition metals such as titanium and niobium is achieved by surface oxidation and/or nitridation: due to interference phenomena which takes place at the air-oxide/nitride-metal interfaces, an oxidized/nitridized surface acquires particular color tones depending on the thickness of the oxide/nitride layer.

Accordingly, in an embodiment of the disclosure, there is provided a metal article with oxidized and/or nitridized surface layer for a picture print, wherein the metal article contains (i) at least one layer comprising a metal such as titanium or niobium, and (ii) at least one oxidized and/or nitridized layer chemically bonded to the metal. In another embodiment, there is included a method for creating oxide and/or nitride layers on metal surface with thickness differentials, comprising: (i) depositing a metal surface with a polymer-based masking material according to the negative of the image: coating the lightest areas of the image with more masking material and coating the darkest areas with less masking material; (ii) exposing the masking material-coated metal surface to a suitable environment under conditions sufficient to oxidize and/or nitridize the surface; and (iii) physically or chemically removing the masking material from the surface. In an embodiment of the disclosure, conditions used to oxidize and/or nitridize the metal surface include chemical or physical approaches used to manipulate the thickness of the oxide/nitride layer on the surface of the metal.

### DETAILED DESCRIPTION OF THE INVENTION

### Metallic Picture Print Components

The term “picture print” as used herein refers to a visual picture or the like created and/or rendered on a surface. Examples of visual pictures include, but are not limited to, photographic image and graphic design.

This invention is to overcome the disadvantages of conventional paper-based prints including photographic prints to provide a durable, UV-proof, water-proof metallic print. Interference phenomena at the air-oxide/nitride-metal interface allow details of an image and colors to be created on the surface of the metallic picture print. Unlike conventional print, the metallic print described in this invention does not use inks or pigments which can lead to UV degradation and aging problems. Titanium and niobium used for the metallic print are chemically-inert and the print has a surface covered with protective oxide/nitride thin layers which prevent future chemical reactions.

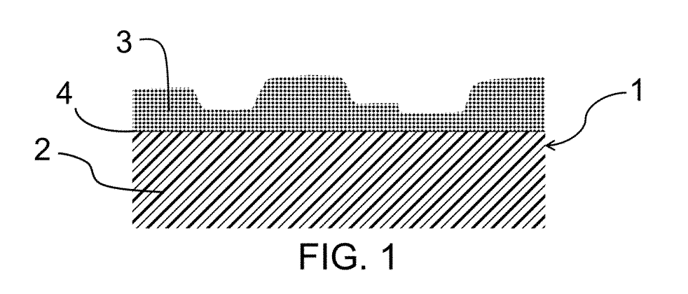

FIG. 1 schematically illustrates a cross-sectional structure of a metallic picture print 1 according to an embodiment of the present disclosure that includes a metal layer 2, and an oxide/nitride layer 3 with thickness variations. The oxide/nitride layer 3 is chemically bonded to the metal surface 4. Specifically, the metal layer 2 serves as a base of the print.

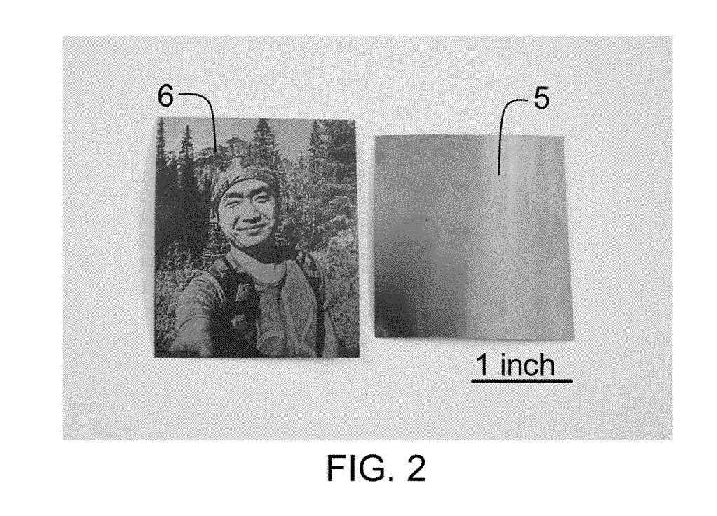

A picture of a titanium metal thin film 5 and a titanium-based metallic picture print 6 is shown in FIG. 2. An interference phenomena-induced high resolution photographic image with a brown-purple color tone was created on the surface of the titanium-based metallic picture print 6.

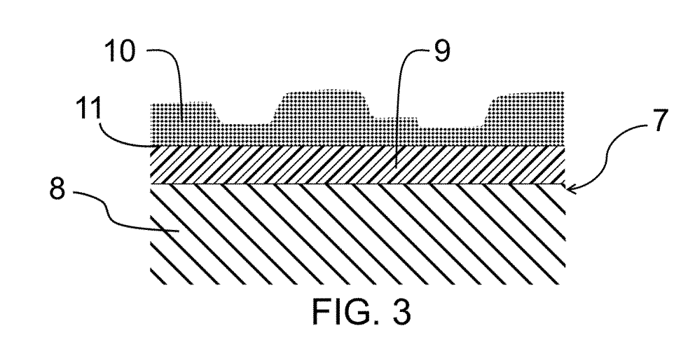

FIG. 3 schematically illustrates a cross-sectional structure of a metallic picture print 7 according to another embodiment of the present disclosure that includes a substrate 8, a deposited metal layer 9, and an oxide/nitride layer 10 with thickness variations. The deposited metal layer 9 is physically and/or chemically bonded to the substrate 8 using a deposition method; the oxide/nitride layer 10 is chemically bonded to the deposited metal surface 11. Specifically, the substrate 8 serves as a base of the metallic picture print. The term “substrate” as used herein refers to any substrate in which the surface can be coated with metals such as titanium, niobium, titanium alloys, and niobium alloys. Examples of substrates include, but are not limited to, plastic films such as (but not limited to) polyethylene, cellulose acetate, polyethylene terephthalate, polyamide, and polypropylene; metal sheets such as (but not limited to) aluminum, copper, and steel; ceramics such as (but not limited to) aluminum oxide, zirconium oxide, indium tin oxide and porcelain; semiconductors such as (but not limited to) silicon; and non-crystalline amorphous solid such as (but not limited to) glass. The term “deposition” as used herein refers to any method in which metals such as titanium, niobium, titanium alloys, and niobium alloys can be coated on a substrate. Examples of deposition methods include, but are not limited to, physical vapor deposition (PVD) such as (but not limited to) pulsed laser deposition (PLD); chemical vapor deposition (CVD) such as (but not limited to) atomic layer deposition (ALD); and chemical-electrical plating approaches.

In another embodiment of the disclosure, the oxide/nitride layer of the metallic picture print is covered with a transparent layer for extra protection or surface color tone modification. Examples of the transparent layers include, but are not limited to, polyurethane, lacquer, acrylic polymer, spar varnish, polyamide and polyethylene. In this embodiment, interference phenomena may also takes place at the transparent layer-oxide/nitride-metal interface.

### Method of the Disclosure

It has been determined that by controlling the thickness of the oxide/nitride layer, the surface acquires particular color tones such as (but not limited to) silver, brown, purple, yellow, cyan, blue, green, and pink.

Accordingly, in an embodiment of the disclosure, there is included a method for controlling the oxide/nitride layer on the surface of a metal such as titanium and niobium, comprising: (i) dissolving masking materials in a solvent to make a masking solution; (ii) coating the surface with the masking solution; (iii) removing the solvent from the coated mask; (iv) curing the masking material; (v) exposing the masking material coated surface to a suitable condition sufficient to induce oxide/nitride layer thickness modification; and (vi) removing the masking material from the surface.

The term “surface” as used herein refers to the surface of a metal article such as titanium-based materials and niobium-based materials. Examples of surfaces include, but are not limited to, untreated metal surface with native oxide, native-oxide removed metal surface, cleaned and degreased metal surface, oxidized and/or nitridized metal surface, metal surface with wettability modification, chemical-coated surface, and chemically and/or physically etched/polished/engraved surface.

In another embodiment, the main ingredient of the masking material utilized to control and manipulate the modification of the oxide/nitride layer is a polymer or a blend of polymers. The methods used to control and manipulate the modification of the oxide/nitride layer on the metal article surface using masking materials include, but are not limited to, varying the masking material coating thickness, varying the permeability and/or impermeability of the masking material for ions, varying the solubility and/or insolubility of the masking material for water or organic solvents, varying the permeability and/or impermeability of the masking material for gases such as oxygen, argon, nitrogen, CO₂, and air, varying the etching resistance of the masking material, and varying the electrical resistivity and/or conductivity of the masking material. In this embodiment, a polymer or a polymer blend is utilized as the masking material or a main ingredient of a masking material for its special water/solvent solubility, electrical conductivity, etching resistance, and ion/gas permeability.

In another embodiment, the thickness of the masking material coated on the surface is greater than 10 nm, optionally between 1 and 1,000 um. Examples of the masking materials include, but are not limited to, acrylic polymer, polyvinyl acetate, polyvinylpyrrolidone, polyvinyl alcohol, polyester, styrene acrylate copolymer, styrene butadiene copolymer, polyamide, polyurethane, polystyrene, epoxy resins, and polyethylene.

In another embodiment, the solvent used to dissolve or partially dissolve the masking material is a liquid or a mixture of liquids. Examples of the solvents include, but are not limited to, dimethyl sulfoxide, methanol, ethanol, toluene, tetrahydrofuran, acetone, dimethylformamide, isopropanol, and water.

In another embodiment, the masking solution is deposited on the surface in a controllable process such as (but not limited to) printing.

In another embodiment, a solvent-removal process is applied to the masking solution coated surface. Examples of the solvent-removal processes include, but are not limited to, drying in air, drying in a vacuum, and drying in a heated oven.

In another embodiment, the masking material is cured during and/or after the solvent removal process. Examples of the curing methods include, but are not limited to, heating, drying, oxidation, nitridation, polymerization, cross-linking, and dehydration.

In another embodiment, the thickness of the oxide and/or nitride layer on the metal article surface is modified using layer thickness modification methods. Examples of layer thickness modification methods include, but are not limited to, anodization, chemical etching, electrochemical etching, photo-induced etching, thermal oxidation/nitridation, chemical oxidation/nitridation, and plasma treatment. In this embodiment, the layer modification method is used to increase or decrease the thickness of the oxide/nitride layer on the surface of the metal article.

In another embodiment, the layer modification may create nanostructures on the surface. The term “nanostructures” as used herein includes nanoscale features or shapes, such as, but not limited to, nanotubes, nanodisks, nanowires, and nanorods. Nanostructures may comprise various materials, including metals and metal oxides.

In another embodiment, the mask material is removed from the surface during and/or after the layer thickness modification process. Examples of mask removal methods include, but are not limited to, dissolving in a solvent, plasma cleaning, and physical removal such as (but not limited to) ultra-sonication.

In another embodiment of the disclosure, there is an extra procedure to either remove or add more masking material to the surface after a successful deposition of the masking material.

In another embodiment of the disclosure, the masking material is directly deposited on the metal article surface without being dissolved in a solvent first.

In another embodiment of the disclosure, the masking material is first deposited on a substrate and then transferred to the metal article surface. In this embodiment, the masking material does not necessarily need to be dissolved in a solvent to be deposit on the substrate.

### EXAMPLES

### Example 1

A titanium-based metallic picture print having two main layers was prepared by electrochemical anodization process using polymer masking materials to achieve oxide layer thickness variations. A 99.9% pure titanium film with native oxide removed by a physical polishing process was cleaned and degreased in methanol. The film was dried in air and a coating process was applied to the metal surface: a negative image of a desired picture was printed on the cleaned and dried metal surface with a resolution of 600 dpi using acrylic polymer-based solutions with a concentration of 10-30% as the “ink”. The printed polymer mask was then dried and cured in air at 200° C. for 5 minutes. The masked titanium surface was then immersed in a 0.9M sodium bicarbonate aqueous solution. An electrochemical anodizing process was applied using a voltage ranging from 10V to 70V. The oxidized titanium was then removed from the electrolyte solution and rinsed with methanol. The polymer mask was then removed from the surface using an organic solvent.

Main composition for the oxide layer is titanium oxides including titanium dioxide (TiO₂). Main composition for the metal layer is up to 99.9% pure titanium.

### Typical Structure for the Metallic Picture Print:

| Layer Name | Main Layer Composition | Typical Layer Thickness | |
|---|---|---|---|
| Oxide Layer | Titanium Oxide | 5-5,000 | nm |
| Metal Layer | Titanium | 0.1-10 | mm |

### Example 2

A flexible titanium-based metallic picture print having three main layers was prepared by electrochemical anodization process using polymer masking materials to achieve oxide layer thickness variations. A 20 um thick titanium layer was first deposited on a transparent polyethylene terephthalate film using pulsed laser deposition. The titanium coated film was rinsed with isopropanol and dried in a nitrogen flow. A coating process was applied to the metal surface: a negative image of a desired picture was printed on the cleaned and dried metal surface with a resolution of 600 dpi using a polyvinyl acetate polymer-based solutions with a concentration of 1-10% as the “ink”. The printed polymer mask was then dried and cured in oxygen at 200° C. for 5 minutes. The masked titanium surface was then immersed in a 0.9M sodium bicarbonate aqueous solution. An electrochemical anodizing process was applied using a voltage ranging from 10V to 70V. The oxidized film was then removed from the electrolyte solution and rinsed with methanol. The polymer mask was then removed from the surface using an organic solvent.

Main composition for the oxide layer is titanium oxides including titanium dioxide (TiO₂). Main composition for the metal layer is titanium.

### Typical Structure for the Metallic Picture Print:

| Layer Name | Main Layer Composition | Typical Layer Thickness | |
|---|---|---|---|
| Oxide Layer | Titanium Oxides/Nitrides | 5-5,000 | nm |
| Metal Layer | Titanium | 0.5-100 | um |
| Substrate Layer | Plastic Film | 0.1-5 | mm |

### Example 3

A titanium-based metallic picture print having three main layers was prepared by an etching process using polymer masking materials to achieve oxide layer thickness variations. A 15 um thick titanium layer was first deposited on a glass substrate using pulsed laser deposition. The titanium coated glass was rinsed with isopropanol and dried in a nitrogen flow. An electrochemical anodizing process was applied to create an oxide layer with a thickness of ˜200 nm on the metal surface. A polymer coating process was then applied to the surface: a negative image of a desired picture was printed on a substrate such as cellulose acetate film using polyester resin and transferred to the surface, the substrate was then removed from the surface. An etching process such as CF₄ plasma etching was applied to the polymer coated surface to decrease the oxide layer thickness. The polymer mask was then removed from the surface.

Main composition for the oxide layer is titanium oxides including titanium dioxide (TiO₂). Main composition for the metal layer is titanium.

### Typical Structure for the Metallic Picture Print:

| Layer # | Main Layer Composition | Typical Layer Thickness | |
|---|---|---|---|
| 1 | Titanium Oxides/Nitrides | 5-5,000 | nm |
| 2 | Titanium | 0.5-100 | um |
| 3 | Glass/Silicon/ITO | 0.1-10 | mm |

1. A metallic picture print comprising:
at least one layer comprising a metal article; at least one layer chemically bonded to said metal article, comprising metal oxides and/or nitrides with thickness variations; and a picture, design, image, graphic, or the like created and rendered on the surface of the print using interference phenomena.

2. The metallic picture print according to claim 1, wherein the metal is a transition metal and its alloys.

3. The metallic picture print according to claim 1, wherein the metal is titanium and its alloys.

4. The metallic picture print according to claim 1, wherein the metal is niobium and its alloys.

5. The metallic picture print according to claim 1, wherein the metal oxide/nitride is a transition metal oxide/nitride.

6. The metallic picture print according to claim 1, wherein the metal oxide/nitride is titanium oxide/nitride.

7. The metallic picture print according to claim 1, wherein the metal oxide/nitride is niobium oxide/nitride.

8. The metallic picture print according to claim 1-7, wherein the oxide and/or nitride layer comprising nanostructures.

9. The metallic picture print according to claim 1-8, wherein the metal is deposited on a substrate.

10. The metallic picture print according to claim 1-9, wherein a transparent material is coated on the surface of the picture print.

11. A method of producing a metallic picture print, comprising: depositing the surface of a metal article with masking materials, wherein the masking materials have at least one polymer component utilized for its special water/solvent solubility, electrical conductivity, etching resistance, and ion/gas permeability; exposing the masking material-coated surface to a suitable condition sufficient to modify the oxide/nitride layer thickness; and removing the masking materials from the surface.

12. The method as claimed in claim 11, wherein a polymer or a polymer blend is utilized as the masking material or an ingredient of a masking material.

13. The method as claimed in claim 11, wherein the masking material is first dissolved in a solvent and then deposited on the surface of the metal article.

14. The method as claimed in claim 11, wherein the masking material is first deposited on a substrate and then transferred to the surface of the metal article.

15. The methods as claimed in claim 11-13, wherein the masking material is cured on the metal article surface.
